(19) United States
(12) Patent Application Publication
(10) Pub. No.: US 2011/0060849 A1
(43) Pub. Date: Mar. 10, 2011

(54) MONITORING METHOD AND KEYBOARD VIDEO MOUSE SWITCH

(75) Inventor: Sheng-Peng Lin, Surrey (CA)

(73) Assignee: ATEN INTERNATIONAL CO., LTD., Taipei County (TW)

(21) Appl. No.: 12/554,030

(22) Filed: Sep. 4, 2009

(51) Int. Cl. G06F 3/00

(52) U.S. Cl. 710/15

(57) ABSTRACT

A monitoring method for monitoring operations performed via a first console device, which comprises the following steps. Firstly, a keyboard, video, and mouse (KVM) switch is provided, wherein the KVM switch comprises a plurality of video processing units for implementing multiple video processing channels KVM switching. Next, in response to a first login command provided by the first console device, a first channel between the first console device and a first computer is established for transmission. A first video processing unit among the plurality of video processing units is employed to process first video signals transmitted between the first console device and the first computer. Then, whether a second console device has a monitoring authority is determined in response to a second login command provided by the second console device; if so, the next step is performed to provide the first video signal to the second console device.

### BACKGROUND OF THE INVENTION

1. Field of the Invention

The invention relates in general to a keyboard, video and mouse (KVM) switch, and more particularly to a KVM switch capable of implementing an operation monitoring function between clients.

2. Description of the Related Art

Referring to FIG. 1, a block diagram of a conventional keyboard, video, and mouse (KVM) system is shown. A KVM system 100 includes a number of operation processor cores and a number of user interface devices. In some specific occasions, a user (or more than one user) has to control more than one computer. In this case, the user interface devices of the computers are disadvantageously in idle states for a long time and occupy a lot of space. Thus, a KVM switch 200 is provided to control more than one operation processor cores with one user interface device or more than one user interface devices. In an example, the number of the user interface devices is smaller than that of the operation processor cores. Thus, the user interface devices of the computers can be effectively saved. For example, an operation processor core OPC includes a central processing unit (CPU) 102, a mainboard 104, a memory 106 and a hard drive 108. A user interface device UID includes a keyboard 110, a mouse 112 and a display 114.

However, the technology changes with each passing day, so it is an important subject of the invention to develop more convenient functions in the KVM switch and thus to enhance the value of the KVM switch.

### SUMMARY OF THE INVENTION

The invention is directed to a keyboard, video and mouse (KVM) switch capable of providing video signal, which are transmitted between a first console device and a computer to a second console device. Thus, a second user can monitor operations, which are executed by a first user via the first console device, via the second console device.

According to a first aspect of the present invention, a monitoring method for monitoring operations performed via a first console device is provided. The monitoring method comprises the following steps. Firstly, provide a keyboard, video, and mouse (KVM) switch, wherein the KVM switch comprises a plurality of video processing units for implementing multiple video processing channels KVM switching. Next, in response to a first login command provided by the first console device, the KVM switch establishes a first channel between the first console device and a first computer for transmission. A first video processing unit among the plurality of video processing units is employed to process first video signal transmitted between the first console device and the first computer. Then, the KVM switch determines whether a second console device has a monitoring authority in response to a second login command provided by the second console device; if so, the KVM switch performs the next step to provide the first video signal to the second console device.

According to a second aspect of the present invention, a KVM switch for allowing a user monitoring operations performed via a console device, such as a first console device, is provided. The KVM switch comprises a video switch circuit and a processor. The video switch circuit, which comprises a first video processing unit and a second video processing unit, is for implementing multiple video processing channels between the computers and the console devices. The processor, in response to a first login command provided by the first console device, the KVM switch establishes a first channel between the first console device and a first computer for transmission by means of employing the first video processing unit to process first video signal transmitted between the first console device and the first computer. The processor of the KVM switch further determines whether a second console device has a monitoring authority in response to a second login command provided by the second console device. When the second console device has the monitoring authority, the processor of the KVM switch provides the first video signals to the second console device in response to a selection command provided by the second console device

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a block diagram of a conventional computer.

FIG. 2 is a block diagram a KVM switch according to a present embodiment of the invention.

FIG. 3 is a detailed block diagram of the video switch circuit 204 shown in FIG. 2.

FIG. 4 a detailed block diagram of the video processing unit 204a1 shown in FIG. 3.

FIG. 5 is another block diagram of a KVM switch according to the present embodiment of the invention.

FIG. 6 is still another block diagram of a KVM switch according to the present embodiment of the invention.

FIG. 7 is still another block diagram of a KVM switch according to the present embodiment of the invention.

FIG. 8 is a flow chart of a monitoring method according to the present embodiment of the invention.

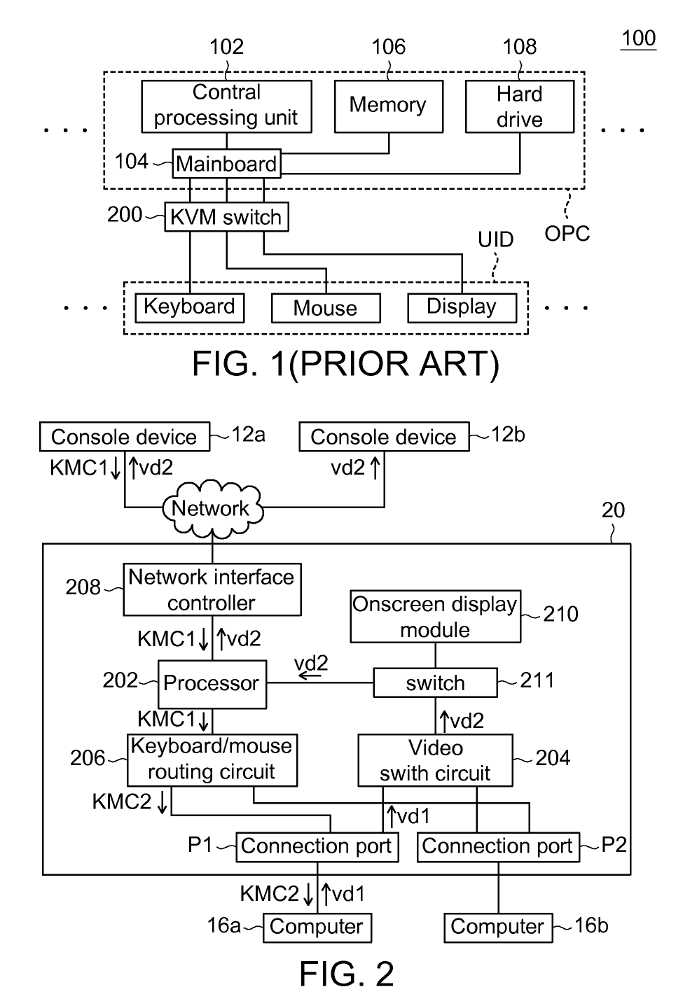

### DETAILED DESCRIPTION OF THE INVENTION

The keyboard, video and mouse (KVM) switch of this embodiment capable of providing video signals, which are transmitted between a first console device and a computer, to a second console device, so that a second user can monitor operations, which are executed by a first user via the first console device, via the second console device.

FIG. 2 shows a block diagram of the KVM switch according to the present embodiment of the invention. The KVM switch 20 is connected to a number of console devices and a number of computers for managing the connections between the console devices and the computers. For example, two console devices 12a and 12b and two computers 16a and 16b are connected to the KVM switch 20. Each of the console devices 12a and 12b may include a set of keyboard, a mouse and a video monitor. Each of the console devices 12a and 12b may further include a computing device, such as a desktop or laptop computer, for performing software capable of communicating with the KVM switch 20 according to TCP/TP protocol or Ethernet protocol.

The KVM switch 20 includes a processor 202, video switch circuit 204, keyboard/mouse routing circuit 206, a network interface controller (NIC) 208, and connection ports P1 and P2. The keyboard/mouse routing circuit 206 may consist of a plurality of controllers, each of which corresponds to each of the computers. That is, thee are at least a first controller corresponding to the first computer 16a and a second controller corresponding to the second computer 16b. Each of the controller acts as a simulated keyboard or a mouse for each of the computers. In this way, the computers connected to the KVM switch 20 can boot normally. Each of the controllers may further parse commands form the corresponding keyboard or a mouse and then transmit the parsed commands to the processor 202 or the corresponding computer. Then, the processor 202 or the corresponding computer acts in response to the parsed commands. In one preferred embodiment, the controller is implemented by an ASIC. The console devices 12a and 12b, located remotely, are coupled to the NIC 208 via a network. The first computer 16a and the second computer 16b are respectively connected to the connection ports P1 and P2 via KVM wires capable of transmitting keyboard commands, mouse commands, and video signals therebetween. The connection ports P1 and P2 are further in communication with the video switch circuit 204, so as to provide the video signals from the computer 16a and the computer 16b to the video switch circuit 204. For example, the connection port P1 receives video signals vd1 from the first computer 16a and then transmits the video signals vd1 to the video switch circuit 204. The connection port P1 or P2 may include a RJ-45 connector for connecting a CAT-5 cable. Further more, there may be an adapter interposed between the connection port P1 or P2 and the computer 16a or 16b. That is, the adapter couples the computer 16a or 16b to the KVM switch 20. The adapter is used to transform and recovery video signals and keyboard/mouse commands transmitted between the KVM switch 20 and the first computer 16a as well as the second computer 16b. For example, the video signals from the first computer 16a are transformed from single-ended to differential mode as input signals of the connection port P1 by the adapter.

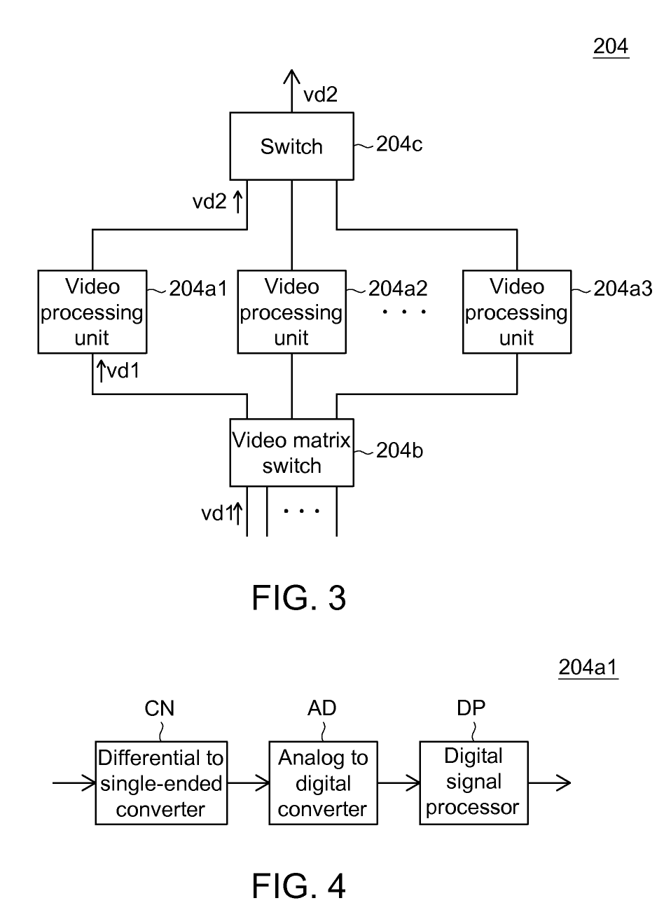

FIG. 3 shows a detailed block diagram of the video switch circuit 204 shown in FIG. 2. The inputs of the video switch circuit 204 are connected to the connection port P1 and the connection port P2. The outputs of the video switch circuit 204 are in communication with the processor 202. The video switch circuit 204 further includes a video matrix switch 204b and N video processing units 204a1 to 204aN for implementing multiple video processing channels KVM switching, wherein N is a natural number greater than 1. The video matrix switch 204b is implemented with 40 input pins capable of receiving 40 video signals provided by different computers and implemented with N output pins capable of outputting N output signals to the respective N video processing units. The video matrix switch 204b may consist of one or more than one video matrix switches. For example, the video matrix switch 204b may include three smaller video matrix switch having 16 inputs and 5 outputs. That is, in the present embodiment, there are N video processing channels are provided. In one example, 2 of the 40 input pins of the video matrix switch 204b are coupled to the respective connection ports P1 and P2, so as to route the video signals vd1 from the computer 16a and the video signals vd2 from the computer 16b to the processor 202.

Each of the video processing units 204a1 to 204aN is employed as a video processing channel for independently carrying out video signal processing operations corresponding to video signal provided by the computers. In other words, the KVM switch 20 is implemented with multiple video processing channels and capable of independently carrying out video processing operations on the respective video signals, which are provided by the computers and then sent to the respective console devices after being processed by the processor 202. That is to say, when a number of console devices are paired with a number of respective computers, the video signal provided by the computers can be processed and sent to the respective console devices via the respective video processing channels.

FIG. 4 shows a detailed block diagram of the video processing unit 204a1 shown in FIG. 3. The video processing units 204a1 to 204aN have substantially the same circuit structure and the circuit structure of the video processing unit 204a1 is used as an example for detailed description. For example, the video processing unit 204a1 includes a differential to single-ended converter CN, an analog to digital converter AD, and a digital signal processor DP. As mentioned above, there may be an adapter (not shown) interposed between each of the computers and each of the connection ports of the KVM switch 20. The adapter is used to extend the distance between the computers and the KVM switch 20. The adapter transforms the single-ended video signals outputted form the computers to video signals in differential mode for longer distance. The differential to single-ended converter CN are in communication with the connection port P1 or P2, and converts video signal, which is in differential format, for example, provided by the first computer 16a into single ended format. However, if there is no adapter interposed between KVM switch 20 and the computer 16a or 16b, and the video signals from the computer is in single-ended format already, the converter CN can be omitted. That is, if in a KVM switch there is no adapter used, the converter CN is not required. The analog to digital converter AD converts the video signal in single-ended format into their digital format. The digital signal processor DP carries out digital processing on the video signal in digital format. The digital signal processor DP may perform compression complies with JPEG, MEPG or H.264 standard.

The video switch circuit 204 may further include a switch 204c, which is capable of receiving N input video signals (provided by the N video processing units 204a1 to 204aN) and providing at least one of them to the processor 202, if the processor 202 has not enough input/output pins. Thus, controlled by the processor 202, the video switch circuit 204 performs switch/processing operations on video signal provided via the connection ports P1 and P2 (i.e. the video signal respectively provided by the computer 16a and computer 16b), so as to provide the switched/processed video signals to the processor 202. The processor 202 is further connected to the NIC 208, so as to transmit video signal to the console devices 12a and 12b via a network, such as the Internet or a LAN (i.e. Ethernet). Referring to FIG. 2, the keyboard/mouse routing circuit 206 is connected between the processor 202 and the connection ports P1 and P2. Controlled by the processor 202, the keyboard/mouse routing circuit 206 performs keyboard/mouse command routing/processing operations. The processor 202 is further connected to the NIC 208, so as to route keyboard/mouse commands from the console devices 12a and 12b to the selected computer via the network.

In one embodiment, a first user operating the first console device 12a performs a computer console operation on the computer 16a. For example, the first user provides a first login command to the KVM switch 20 via the console device 12a. The processor 202, in response to the first login command, establishes a first communication channel between the first console device 12a and the first computer 16a, so that the console device 12a can perform the computer console operation on the computer 16a via the KVM switch 20. The NIC 208, processor 202, video switch circuit 204 and keyboard/mouse routing circuit 206 are incorporated for implementing the first communication channel.

The first communication channel includes a video processing channel implemented by the processor 202 and the video switch circuit 204. For example, in response to the first login command, the processor 202 controls the video matrix switch 204b provides the video signal vd1 to the video processing unit 204a1, so that the video processing unit 204a1 is used for processing the video signal vd1 and accordingly obtaining processed video signal vd2. The processed video signal vd2 is received by the processor 202 and then provided to the console device 12a via the NIC 208. Thus, the video processing unit 204a1 is employed in the video processing channel to process the video transmitted between the first console device 12a and the first computer 16a.

The first communication channel further includes a keyboard/mouse command channel implemented by the processor 202 and the keyboard/mouse routing circuit 206. For example, via the NIC 208, the processor 202 receives keyboard/mouse commands KMC1 provided by the console device 12a. The processor 202 further transmits the keyboard/mouse commands KMC1 to the keyboard/mouse routing circuit 206 and accordingly provides processed keyboard/mouse commands KMC2 to the computer 16a via the connection port P1. Thus, via the keyboard/mouse command channel, the keyboard/mouse commands KMC2 provided by the console device 12a can be processed and transmitted to the computer 16a. As a result, via the video processing channel and the keyboard/mouse command channel, the first user can effectively perform the computer console operation on the computer 16a.

In an embodiment, a second user operating the console device 12b wants to monitor the computer console operation of the first user. For example, the second user provides a second login command, followed by a selection command, such as a hotkey command, to the KVM switch 20 via the console device 12b. In response to the second login command and the selection command, the processor 202 determines whether the second user has a monitoring authority for monitoring the operations, which are performed via the console device 12a, of the first user. When the second user has the monitoring authority, the processor 202 provides the first video signal, which is processed by the video processing unit 204a1 to the console device 12b. Thus, the second user can monitor the computer console operation of the first user via the second console device 12b.

In an embodiment, as shown in FIG. 2, the KVM switch 20 further includes a switch 211 and an on screen display (OSD) module 210, for selectively mixing OSD video signal with the video signal transmitted between the console devices 12a and 12b as well as the computers 16a and 16b, so that an OSD menu can be provided to the corresponding console device and the user can further perform a KVM console operation via the provided OSD menu. For example, the first login command, the second login command and the selection command are inputted via the corresponding OSD menus provided to the console devices 12a and 12b. Alternatively, rather than the OSD module, the KVM switch 20 further includes a PIP (picture-in-picture) module or POP (picture-of-picture) module 210 for providing one of the first and second console devices 12a and 12b with frames representing the first video signals and the second video signals simultaneously. For example, the first video signals are provided as the foreground and the second video signals are provide as the background, and vice versa. The PIP or POP module 210 is able to scale down and mix the received first or second video signals to form PIP or POP frames to be transmitted to the console devices 12a and 12b.

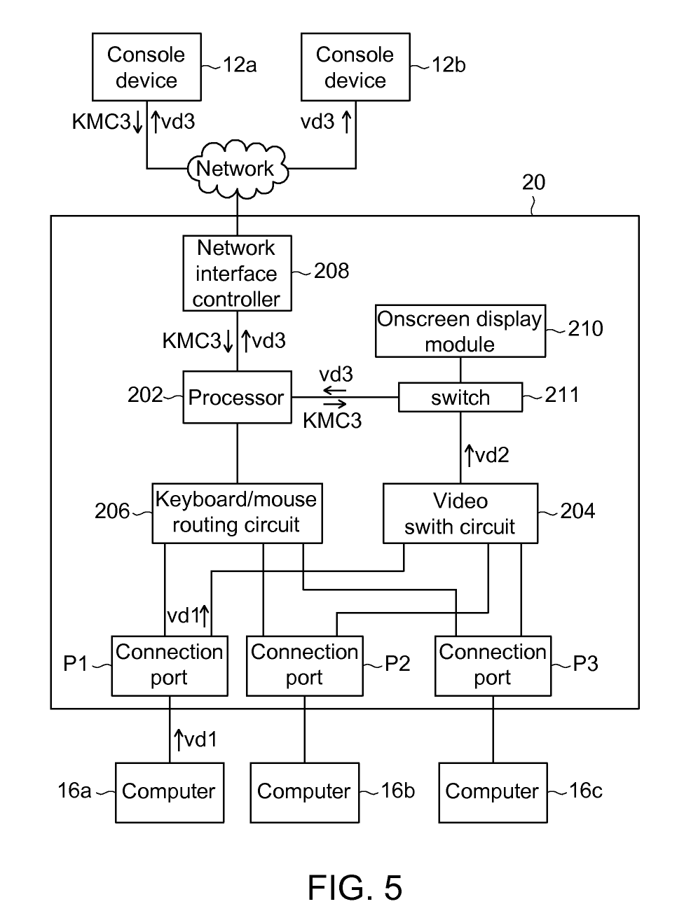

FIG. 5 shows another block diagram of the KVM switch according to the present embodiment of the invention. In an embodiment, the first user may also trigger a hot key operation event via the second console device 12b. For example, the hot key operation event corresponds to the event occurred when the second user presses the key “ESC” on the keyboard. In response to the hot key operation event, the processor 202 drives the OSD module 210 mixing first OSD video signal to the processed video signal vd2, so that the OSD module 210 accordingly obtains and provides a mixed video signal vd3. The processor 202 further provides the mixed video signal vd3 to the console device 12a via the NIC 208, so that an OSD interface is provided to the console device 12a. Thus, the first user can perform the KVM console operation via the OSD interface.

For example, the OSD module 210 can be implemented with an OSD video signal source and a multiplexer. The OSD video signal source generates the OSD video signal representing a menu in response to the keyboard/mouse commands KMC3. The multiplexer selectively provides one of the OSD video signal and the processed video signal vd2 in response to the video vertical synchronous information and video horizontal synchronous information of each video signal frame, so as to obtain the mixed video signal vd3.

In an embodiment, the processor 202 can provide the mixed video signal vd3 to the console device 12b in response to the second login command and the selection command. In other words, the second user can also monitor the KVM console operation of the first user via the console device 12b.

In an embodiment, there is another computer 12c is coupled to the KVM switch 20 and the first user inputs a port-reestablishing command via the console device 12a and the processor 202 accordingly re-establishes the first communication channel, which originally connects the console device 12a and the computer 16a, connecting the console device 12a and another computer, such as the computer 16c.

Though only the situation that the console devices 12a and 12b are coupled to the KVM switch 20 via NIC 208 and network paths is cited as an example for illustration in the up-mentioned paragraphs, the console devices, both the console devices controlled by a monitored user (i.e. the first user) and that controlled by a monitoring authorized user (i.e. the second user), can also be connected to the KVM switch via other communication link.

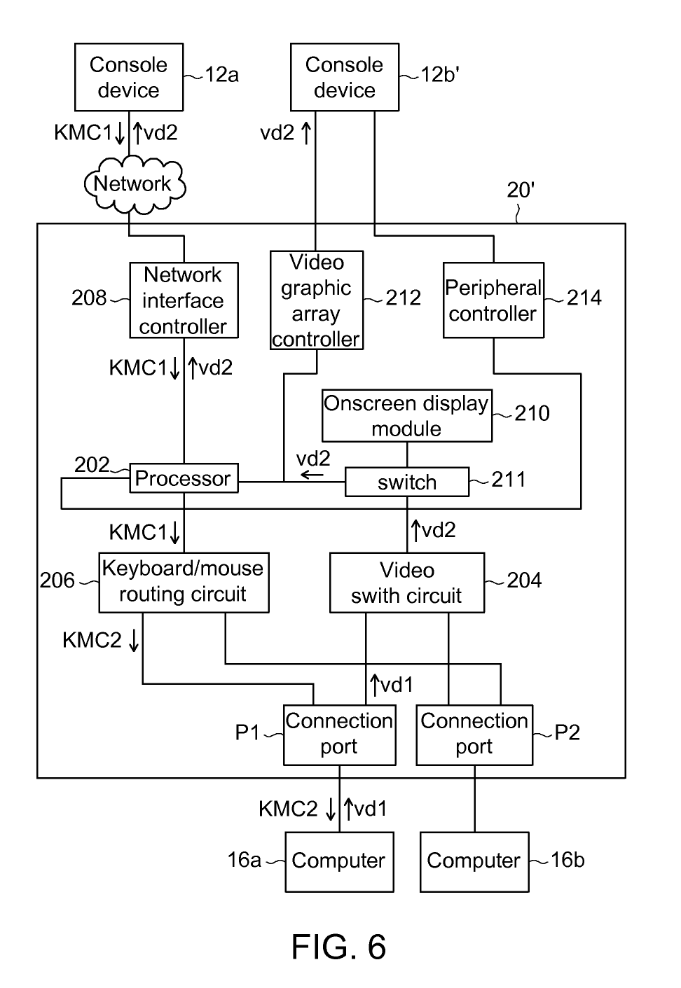

FIG. 6 shows still another block diagram of the KVM switch according to the present embodiment of the invention. For example, the console device 12c is positioned at a near end of the KVM switch 20′ and is connected to the KVM switch 20′ via a video graphics array (VGA) controller 212 in communication with the video switch circuit 204 and a cable. For example, the processed video signals vd2 (or the mixed video signals vd3 can be transmitted to the console device 12c via the VGA controller 212 and the video cable when the second user's monitoring authority is verified. In this way, a user of the console device 12c, located locally, can monitor the operations of the console device 12a, located remotely, on the computer 16a. In an example, the KVM switch 20′ further includes a peripheral controller 214 in communication with the console device 12c and the processor 202 for parsing of the keyboard/mouse command provided by the console device 12c. The peripheral controller 214 may act as a simulated keyboard and/or mouse for the KVM switch 20′.

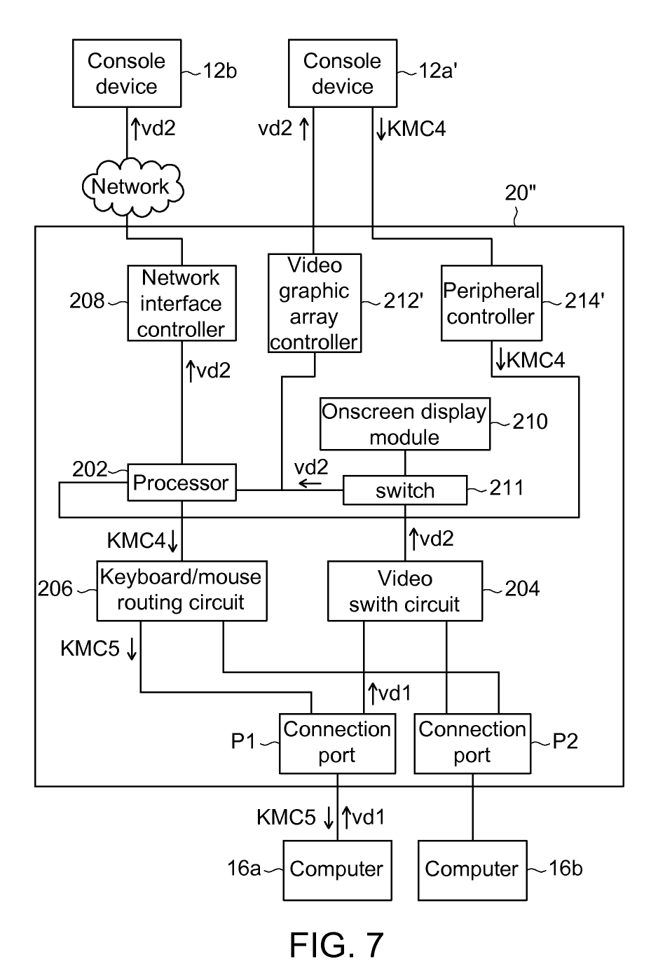

FIG. 7 shows still another block diagram of the KVM switch according to the present embodiment of the invention. For example, the console device 12c is positioned at the near end of the KVM switch 20″ and is connected to the KVM switch 20″ via a VGA controller 212′ in communication with the video switch circuit 204 and a cable. It can be obtained that the processor 202 can provide the processed video signal vd2 (or the mixed video signal vd3) to the console device 12c via the VGA controller 212′ and the cable such that a user of the console device 12b, located remotely, can monitor the operations of the console device 12c, located locally, on the computer 16a. The KVM switch 20″ further includes a peripheral controller 214′ in communication with the console device 12c and the processor 202 for parsing the keyboard/mouse commands KMC4 provided by the console device 12a′ and providing them to the processor 202. In a master-slave architecture, the peripheral controller 214′ may act as a simulated host for the keyboard or mouse.

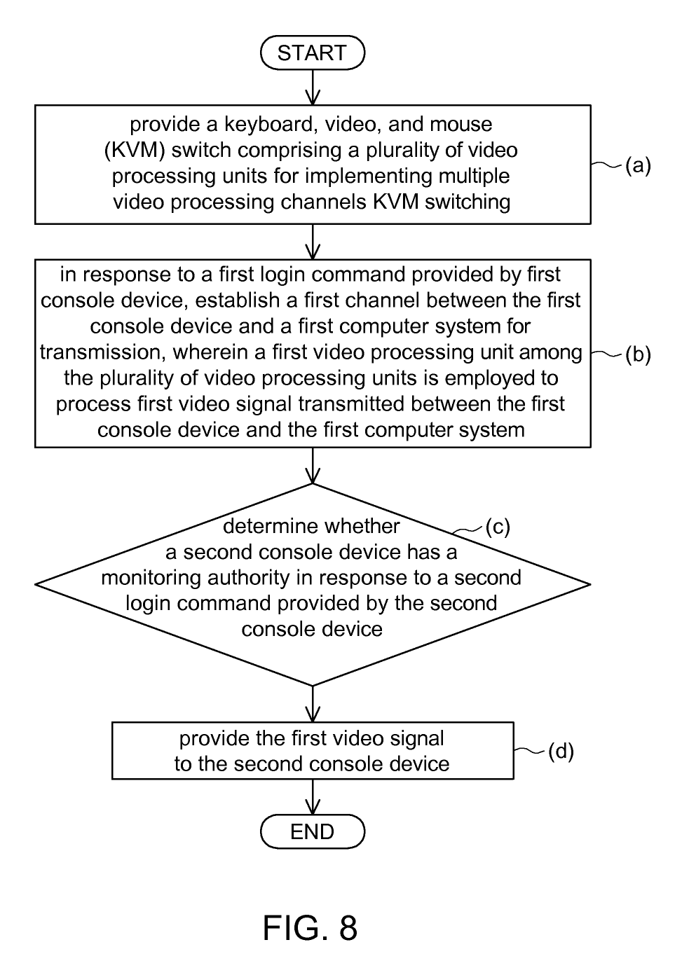

FIG. 8 shows a flow chart of the monitoring method according to the present embodiment of the invention. The monitoring method includes the following steps. Firstly performing step (a), a KVM switch 20 with a number of video processing units 204a1 to 204aN for implementing multiple video processing channels between computers and console devices is provided. Next performing step (b), a first channel between the console device 12a and the computer 16a for transmission, wherein the video processing unit 204a1 among the video processing units 204a1 to 204aN is employed to process video signal transmitted between the console device 12a and the computer 16a.

Then performing step (c), in response to the second login command provided by the console device 12b, whether the console device 12b has the monitoring authority is determined by the KVM switch 20. After that, step (d) is performed to provide the video signal transmitted between the first console device 12a and the first computer 16a to the second console device 12b, so as to achieve the monitoring operation.

The KVM switch according to the present embodiment of the invention is capable of providing video signal, which are transmitted between a first console device and a first computer, to a second console device. Thus, a second user can monitor operations, which are executed by a first user via the first console device, via the second console device.

Though, only the situation that two console devices and two/three computers are connected to the KVM switch is illustrated in the above embodiments, the numbers of console device and computer connected to the KVM switch are not limited thereto. In other embodiments, more than two console devices and more than two/three computers are connected to the KVM switch.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A monitoring method, for monitoring operations performed via a first console device, the monitoring method comprising the steps of:
(a) providing a keyboard, video, and mouse (KVM) switch, the KVM switch having a plurality of video processing units for implementing multiple video processing channels KVM switching;
(b) in response to a first login command provided by the first console device, establishing a first channel between the first console device and a first computer for transmission, wherein a first video processing unit selected from the plurality of video processing units is employed to process first video signal transmitted between the first console device and the first computer;
(c) determining whether a second console device has a monitoring authority in response to a second login command provided by the second console device, if so, performing step (d); and
(d) providing the first video signal to the second console device.

2. The method according to claim 1, further comprising:
(e) mixing first on screen display (OSD) video signal to the first video signal, so that a first OSD interface is provided to the first console device, wherein the first login command is inputted via the first OSD interface.

3. The monitoring method according to claim 1, further comprising:
(b′) in response to the second login command provided by the second console device, establishing a second channel between the second console device and a second computer for transmission, wherein a second video processing unit selected from the plurality of video processing units is employed to process second video signal transmitted between the second console device and the second computer.

4. The method according to claim 3, further comprising:
(e′) mixing second OSD video signal to the second video signal, so that a second OSD interface is provided to the second console device, the second login command and the selection command inputted via the second OSD interface.

5. The method according to claim 1, further comprising:
(f) in response to a port-reestablishing command provided by the first console device, re-establishing the first communication channel, which originally connects the first console device and the first computer, connecting the first console device to the first computer or a third computer.

6. The monitoring method according to claim 1, further comprising:
(g) in response to a hotkey command provided by the first console device, selectively performing step (e′); and
(e′) mixing second OSD video signal to the second video signal, so that a second OSD interface is selectively provided to the second console device.

7. A keyboard, video, and mouse (KVM) switch, for monitoring operations performed via a first console device, the KVM switch comprising:
a video switch circuit, for implementing multiple video processing channels KVM switching, the video switch circuit comprising a first video processing unit and a second video processing unit;
a processor, in response to a first login command provided by the first console device, establishing a first channel between the first console device and a first computer for transmission by means of employing the first video processing unit to process first video signal transmitted between the first console device and the first computer,
wherein the processor further determines whether a second console device has a monitoring authority in response to a second login command provided by the second console device; and
wherein when the second console device has the monitoring authority, the processor provides the first video signal to the second console device in response to a selection command provided by the second console device.

8. The KVM switch according to claim 7, wherein the video switch circuit further comprising:
a video matrix switch, comprising a plurality of first input ends, which are connected to the first and the second computers, respectively, and a plurality of second output ends, which are connected to the first and the second video processing units, respectively, the video matrix switch controlled by the processor for matching the first video processing unit to the first computer.

9. The KVM switch according to claim 7, wherein:
in response to a second login command provided by the second console device, if the selection command is not received, the processor establishes a second channel between the second console device and a second computer for transmission by means of employing the second video processing unit to process second video signal transmitted between the second console device and the second computer.

10. The KVM switch according to claim 7, further comprising:
an on screen display (OSD) module, for mixing first OSD video signal to the first video signal, so that a first OSD interface is provided to the first console device, the first login command inputted via the first OSD interface.

11. The KVM switch according to claim 10, wherein the OSD module further mixes second OSD video signal to the second video signal, so that a second OSD interface is provided to the second console device, the first login command inputted via the first OSD interface.

12. The KVM switch according to claim 7, wherein:
in response to a port-reestablishing command provided by the first console device, the processor re-establishes the first communication, which originally connects the first console device and the first computer, connecting the first console device to the first computer or a third computer.

13. The KVM switch according to claim 7, wherein:
in response to a hotkey command provided by the first console device, the processor selectively mixes second OSD video signal to the second video signal, so that a second OSD interface is selectively provided to the second console device.

14. A keyboard, video, and mouse (KVM) system, comprising:
a first console device and a second console device;
a first computer;
a KVM switch, for monitoring operations performed via a first console device, the KVM switch comprising:
a video switch circuit, for implementing multiple video processing channels KVM switching, the video switch circuit comprising a first video processing unit and a second video processing unit; and
a processor, in response to a first login command provided by the first console device, establishing a first channel between the first console device and the first computer for transmission by means of employing the first video processing unit to process first video signal transmitted between the first console device and the first computer,
wherein the processor further determines whether the second console device has a monitoring authority in response to a second login command provided by the second console device; and
wherein when the second console device has the monitoring authority, the processor provides the first video signal to the second console device in response to a selection command provided by the second console device.

15. The KVM system according to claim 14, wherein the video switch circuit further comprising:
a video matrix switch, comprising a plurality of first input ends, which are connected to the first and the second computers, respectively, and a plurality of second output ends, which are connected to the first and the second video processing units, respectively, the video matrix switch controlled by the processor for matching the first video processing unit to the first computer.

16. The KVM system according to claim 14, further comprising:
a second computer, wherein in response to a second login command provided by the second console device, if the selection command is not received, the processor establishes a second channel between the second console device and the second computer for transmission by means of employing the second video processing unit to process second video signal transmitted between the second console device and the second computer.

17. The KVM system according to claim 14, further comprising:
an on screen display (OSD) module, for mixing first OSD video signal to the first video signal, so that a first OSD interface is provided to the first console device, the first login command inputted via the first OSD interface.

18. The KVM system according to claim 17, wherein the OSD module further mixes second OSD video signal to the second video signal, so that a second OSD interface is provided to the second console device, the first login command inputted via the first OSD interface.

19. The KVM system according to claim 14, further comprising:
a third computer, wherein in response to a port-reestablishing command provided by the first console device, the processor re-establishes the first communication, which originally connects the first console device and the first computer, connecting the first console device to the first computer or a third computer.

20. The KVM system according to claim 20, wherein:
in response to a hotkey command provided by the first console device, the processor selectively mixes second OSD video signal to the second video signal, so that a second OSD interface is selectively provided to the second console device.
